(19) United States
(12) Patent Application Publication
(10) Pub. No.: US 2009/0149200 A1
(43) Pub. Date: Jun. 11, 2009

(54) System and method for device or system location optimization

(75) Inventors: Parakrama Jayasinghe, Rajagiriya (LK); Dickson Jayasuriya, Rajagiriya (LK); James Morely-Smith, Wokingham (GB); Ruwan Jayanetti, Rajagiriya (LK)

Correspondence Address: Motorola- Amin, Turocy & Calvin, LLP, 127 Public Square, 57th Floor, Key Tower, Cleveland, OH, 44114, US

(73) Assignee: SYMBOL TECHNOLOGIES, INC., Holtsville, NY (US)

(21) Appl. No.: 11/953,759

(22) Filed: Dec. 10, 2007

(51) Int. Cl. H04Q 7/20

(52) U.S. Cl. 455/456.3

(57) ABSTRACT

Systems, devices and/or methods that facilitate location optimization of mobile devices and/or systems are presented. Location optimization can result in an improved user experience by providing information and/or software tailored to the location of the device and/or system. Location aware devices/systems can include a deterministic or inferential determination of the granular location of the device/system. Location aware devices/systems can also include deterministic or inferential determinations of potential location zone transitions. These determinations and/or inferences can be employed to determine the availability of, and relevance of, device/system updates. Available relevant updates can be downloaded to the device/system at varying levels of granularity and overlap. The downloaded updates can then be installed and made available to the user.

### TECHNICAL FIELD

The subject innovation relates generally to mobile devices, systems, and/or methods and more particularly to location aware updates of mobile devices and/or systems to facilitate location optimization of said mobile devices and/or systems.

### BACKGROUND

Traditionally, mobile systems and/or devices, such as cellular telephones, personal digital assistants (PDAs), laptop computers, GPS devices, and radios, among others, employ only very crude location aware update systems (e.g., a cell phone can update to local time because a local time signal can be sent from a nearby cellular tower, among others). These basic update systems can fail to provide a rich update of the mobile device and/or system. For example, while a cell phone can update the display time based on a transmission from a nearby cell tower, it can fail to update properly where the cell phone tower is in a first time zone and the cell phone, while near to the first cell tower, is actually located in the neighboring time zone (e.g., a cell phone can be on the Idaho side of the Idaho-Montana border but can receive a time update from a cell tower on the Montana side of the border, resulting in the cell phone displaying Mountain time while the cell phone is actually in the Pacific time zone).

These conventional update systems are typically limited in the nature of the device or system updates that can be enabled. For example, conventional systems, when moving from one location to another, typically do not update from a remote source, for example, a sales database with local tax rules, local shipping rules, local customer contacts, or the like. Similarly, where a device approaches a boundary between two location zones, the device is unlikely to anticipatorily update from a remote source, for example, radio stations, contact lists, maps, weather information, traffic information, transportation information (e.g., bus routes, airport locations, taxi stands, rental car locations, . . . ), pricing schemes, rules of the road, or combinations thereof among numerous other examples.

Further, updates are typically not based on a device location but are rather based on the location of the updating entity. For example, were a cell phone can have a time display updated, the update is generally based on the location of the cell tower transmitting the update. Alternatively, users can actively seek out updates in conventional systems. For example, a GPS user can actively seek out a map update. Further, where updates are available and the user can seek them out, they can often be retrievable only through another device, such as a personal computer or laptop. For example, where a GPS can update a map set, the new maps frequently must be downloaded through a personal computer to a memory device that is then transferred to the GPS to communicate the new map information.

Even where devices appear to access location specific information, these systems can merely be accessing pools of data only marginally related to the location. For example, modern GPS systems appear to gather local traffic information related to the route the GPS can be displaying. This system can actually be accessing a pool of data for an entire region, similar to a cell phone getting local time from a nearby cell tower. In other words, the traffic data is not based on the specific location of the GPS device but rather is related to the GPS device being near a data source broadcasting traffic updates for all GPS devices located within the broadcast area. Thus even where data access can appear to be device location related, it is frequently data source related.

Device and/or system end users can benefit from rich updating of mobile devices and/or systems. Where these rich updates can be updated from a remote source by a location aware mobile device and/or system, further benefit can be realized. For example, where a sales person using a mobile aware PDA enters a customer property (e.g., crossing from a first location zone to second location zone) the PDA can determine that the new location has relevant data updates available (e.g., the PDA determines that it is entering a new location zone and that special customer pricing for the new zone is available from a remote source, such as the home office). The PDA can then download the location relevant update (e.g., the special customer pricing) such that when the user access the sales software during a new sale to the customer, the special pricing is used in the sales calculations. Moreover, after the sale as the user leaves the customer property (e.g., moving from the second location zone back to the first location zone) the PDA can in response download the standard pricing data such that any sales calls made to other customers will use standard pricing in those sales calculations.

### SUMMARY

The following presents a simplified summary of the subject innovation in order to provide a basic understanding of some aspects described herein. This summary is not an extensive overview of the disclosed subject matter. It is intended to neither identify key or critical elements of the disclosed subject matter nor delineate the scope of the subject innovation. Its sole purpose is to present some concepts of the disclosed subject matter in a simplified form as a prelude to the more detailed description that is presented later.

Conventionally, devices and systems only marginally localize a device or system to the device or system location. These systems and devices typically gather data related to a source broadcast location rather than the actual location of the device or system being updated. Further, even where a device or system can update to the actual location of the device or system, these updates can require user initiation of the update. Moreover, these updates can require multiple modalities to realize a device update (e.g., downloading an update through a laptop to a memory device for transfer to the device or system to be updated).

In accordance with one aspect of the disclosed subject matter, a system and method for device and/or system location optimization can facilitate device and/or system location sensitive updating. For example, a cellular phone can triangulate the phones location. This location information can, for example, then be used to update a contact list with local emergency telephone numbers, local rental car agency telephone numbers, or local time independent of the time of the broadcasting cellular tower, combinations thereof, and many others. Further, as the device continues to relocate, location zones can be used to indicate when new updates should be sought. For example, as the cell phone moves from one location zone to a second location zone, such as moving from one incorporated city into another bordering incorporated city, the location aware cell phone can determine that updates can be sought. In seeking these updates, the cell phone can determine that the new city has a different set of emergency phone numbers and that a hot new movie is being released that night in the new city. The phone can then update the emergency contact information and inform the user that this can be a good opportunity to be one of the first to see the new movie. In another example, as a user takes a train ride across the country, based on the user's PDA location, the local time can be updated (e.g., based on PDA location rather than the time at the broadcast tower sending the time information), weather conditions for the area around the PDA can be updated, a list of local attractions can be updated, or combinations thereof, among many others.

In another aspect, a device and/or system can be location aware with varying degrees of granularity. For example, GPS data can be used to determine a device/system location, for example, to within 20 feet. Similarly, cell phone tower triangulation can be employed to locate a device/system, for example, to within 150 feet. Devices and/or systems can also use, among others, radio station time signal broadcasts, Wi-Fi or other internet location information (e.g., a device can be given location information based on known hot spot locations, among others), or can employ inertial tracking (e.g., accelerometer system that determines current location based on movement from a last known location) to locate a device/system, for example, to within 10 feet. Other modalities can also be employed to enable a device/system to be aware of the device/system location.

In accordance with another aspect of the disclosed subject matter, a location aware device/system can download localized software in addition to localized data. For example, as a business traveler flies from New York to Paris, a location aware laptop computer can determine that it is entering a different location zone and seek related updates. These updates can include versions of software appropriate for use in the new location zone. For example, the laptop can determine that a French-to-English phrase dictionary software package is available. This dictionary can then be downloaded and the computer can, for example, open this French-to-English phrase dictionary when the user selects a “local phrases” icon on the laptop GUI. As a second example, where a sales tracking software package accesses a local tax module when generating sales documentation, as a sales employee crosses from Washington State to Oregon, a location aware laptop can determine that a new location zone is being entered and seek updates. An Oregon specific tax module can be located and downloaded. When the sales employee accesses the sales software with a customer in Oregon, the Oregon specific tax module can be seamlessly employed. Further, as the sales employee later travels to California, the laptop can again be aware that it has entered a new location zone and seek out and update the sales software with the California tax module.

In another aspect, where location granularity is relatively fine, for example, 10 feet, location aware devices can be further optimized for their specific locations. For example, as a sales employee travels between different offices in a single building when making sales calls, a location aware device can be updated with client specific information. For example, the sales person can uses the PDA to display medical device products to doctors while the sales person is making separate sales calls to an oncologist, an anesthesiologist, and a dentist located in different offices in a single medical tower building.

Continuing with the example, as the sales employee enters the lobby of the medical building, the PDA can, for example, determine from GPS signals that the salesperson is entering the John Doe Medical Building zone (JDMB) and leaving, for example, the main street location zone. The PDA can then seek out and download a list of sales contacts in the JDMB that can be available to the sales employee through the PDA's address book application as the sales person takes the elevator to the 14^{th} floor to visit with the oncologist client. While the concrete of the building can have obfuscated the GPS signals, the PDA can employ inertial tracking to determine that the sales employee is entering the JDMB 14^{th} floor location zone. In response the PDA can seek updates and download, for example, documentation on CAT scan machines. The sales person can then present these to the Oncologists and make a sale.

Upon leaving the oncologist and traveling to the 10^{th} floor to visit the anesthesiologist, the PDA can determine that the JDMB 14^{th} floor location zone has been exited and the 10th floor location zone has been entered. In response the PDA can seek out and download ventilator information. Upon completing a ventilator sale, the sales person can travel to the 9^{th} floor. Again, the PDA can determine that the 10^{th} floor location zone has been exited and the 9^{th} floor location zone has been entered. The PDA can then seek out and download information on dentist drills for yet another successful sale.

Upon exiting the building, the PDA can determine that the JDMB zone has been exited and the Main street location zone has been entered. The PDA can then seek out and download the local restaurant list. The PDA user then, happy with the days sales, can seamlessly look up a great local watering hole to meet her friends at after the great day at work. She is grateful that the location aware PDA device is capable of fine grain location determinations and that she did not have to manually initiate seeking out and downloading the relevant update information.

To the accomplishment of the foregoing and related ends, the innovation, then, comprises the features hereinafter fully described and particularly pointed out in the claims. The following description and the annexed drawings set forth in detail certain illustrative embodiments of the innovation. These embodiments can be indicative, however, of but a few of the various ways in which the principles of the innovation can be employed. Other objects, advantages, and novel features of the innovation will become apparent from the following detailed description of the innovation when considered in conjunction with the drawings.

### BRIEF DESCRIPTION OF THE DRAWINGS

FIG. 1 is a high level diagram of a system that can facilitate location optimization in accordance with an aspect of the subject matter disclosed herein.

FIG. 2 is a simplified diagram of a location component that can facilitate location optimization in accordance with an aspect of the subject matter disclosed herein.

FIG. 3 is a simplified diagram of mobile content management component that can facilitate location optimization in accordance with an aspect of the subject matter disclosed herein.

FIG. 4 illustrates a diagram of a user device/system employing location awareness that can facilitate location optimization in accordance with an aspect of the disclosed subject matter.

FIG. 5 is a schematic illustration of a system to facilitate location optimization in accordance with an aspect of the disclosed subject matter.

FIG. 6 illustrates a methodology that facilitates location optimization in accordance with an aspect of the disclosed subject matter.

FIG. 7 illustrates a methodology that facilitates location optimization in accordance with an aspect of the disclosed subject matter.

FIG. 8 illustrates a methodology that facilitates location optimization in accordance with an aspect of the disclosed subject matter.

FIG. 9 illustrates an inferential methodology that facilitates location optimization in accordance with an aspect of the disclosed subject matter.

FIG. 10 illustrates a block diagram of an exemplary electronic device that can facilitate location optimization in accordance with an aspect of the disclosed subject matter.

### DETAILED DESCRIPTION

The disclosed subject matter is described with reference to the drawings, wherein like reference numerals are used to refer to like elements throughout. In the following description, for purposes of explanation, numerous specific details are set forth in order to provide a thorough understanding of the subject innovation. It is evident, however, that the disclosed subject matter can be practiced without these specific details. In other instances, well-known structures and devices are shown in block diagram form in order to facilitate describing the subject innovation.

Traditional mobile devices and systems generally lack an awareness of the device or system location. Further, even where a device or system can be aware of the device or system location it is generally only a cursory awareness. For example, a cell phone can update a time setting based only generally on the location of the cell phone being within range of a cell tower broadcasting a time signal related not the location of the phone (e.g., other than merely being within range of the cell tower), but is instead related to the position of the cell tower itself.

In one aspect, a device and/or system can be location aware to facilitate location optimization in accordance with an aspect of the subject matter. A location aware device/system can determine with granularity the physical location of the device/system. A device/system, for example, a PDA, cell phone, laptop, GPS receiver, or the like, can determine that it is within, for example, a national location zone, a regional location zone, a state location zone, a county location zone, a municipality location zone, a burrow location zone, a street grid location zone, a neighborhood location zone, an address location zone, a particular floor location zone, a room location zone, and the like. As methods of location improve the granularity with which a location can be determined, the subject innovation can leverage the improved granularity to further improve location optimization. For example, a PDA can determine which floor of an office building it is located on, a cell phone can determine which municipality it is in, a GPS can determine which country it is located in, among others.

In another aspect, numerous modalities can be employed in determining a device/system location to facilitate location optimization in accordance with an aspect of the subject matter. For example, GPS, cell tower triangulation, leveraging Wi-Fi or other inter/intranet systems (such as identification of a particular floor of a building based on the floor's Wi-Fi signal, among many others), inertial tracking (e.g., using accelerometers, among others), inferential determination of location (e.g., inferring the location of a device based on, for example, historical data, pervious direction of travel, last known position, and numerous others), or combinations thereof, among others, can be employed to determine a device/system location with a corresponding granularity. As herein discussed, alternate means and future means of determining a device/system location can facilitate location optimization in accordance with an aspect of the subject matter and such other means as used to facilitate the disclosed subject matter are considered within the scope of the subject innovation.

In another aspect, location optimization can include a device/system enabled to seek updates relevant to the determined or inferred location of the device/system. Updates can be localized to the same or different levels of granularity as the granularity of the location determination or inference. For example, a PDA can seek all updates related to, for example, the John Doe Medical Building (JDMB). Where available updates are not available with that level of granularity (e.g., granularity is more or less fine) alternate updates can be sought at either a higher or lower level of granularity, for example, updates related to the neighborhood in which the JDMB is located, the city in which the PDA is located, or the floor of the JDMB on which the PDA is located, among others.

Further, the device and/or system can seek relevant updates by different means that that employed in determining location. For example, where a PDA uses GPS signals to determine location, relevant updates can be sought over cellular phone connection, Wi-Fi networks, WANs, LANs, ad hoc networks with other device/systems, or combinations thereof, among others. Alternate means and future means of communication to seek relevant updates can similarly facilitate location optimization in accordance with an aspect of the subject matter and all such other means as used to facilitate the disclosed subject matter are considered within the scope of the subject innovation.

In another aspect, updates determined to be relevant can be acquired to facilitate location optimization in accordance with an aspect of the subject matter. These relevant updates can include data and/or software, among others. For example, an update can be a software application, a locally relevant version of a software application, a software module for use with an installed application, compiled or uncompiled software code for execution or storage on the device/system, compressed or uncompressed software, or combinations thereof, among others. Further, an update can be, for example, weather data, traffic data, news data, mapping data, event data, services data, contact information data, exchange rate data, stock price data, unit price data, stock on hand data, future orders data, or combinations thereof, among nearly limitless other types of data.

In another aspect, inferences about what updates to download can be determined to facilitate location optimization. For example, inferences can be made based on the size of the update or portion thereof, dates associated with an update or part thereof, relevance of an update, estimated download times for an update or portion thereof, historical update data (e.g., updates that were or were not, frequently used, . . . ), contextual information (time of day, distances, weather, speed, . . . ), user preferences, among a nearly limitless number of other factors. For example, where a user enters an oncologists office on a sales call, an inference can be made based on prior use of updates, for example, where on prior visits the oncologist only viewed a particular brand of medical device, searches for updates can be limited to updates related to that particular oncologist's location zone and the particular brand of medical device the oncologist is likely to view. Continuing with the example, further inferences can be made that the oncologist can want to view high resolution images and therefore searches for updates can be refined by looking only for those updates containing high resolution images. One of skill in the art will appreciate that the nearly limitless number of factors that can be included in an inferential determination can create a very powerful tool for optimizing the search and download of relevant updates and that all such factors are considered within the scope of the disclosed subject matter.

In an aspect, relevant updates that are downloaded can be installed or otherwise made available to the user to facilitate location optimization in accordance with an aspect of the subject matter. This can include modification of device and/or system settings, for example, adjusting a ring tone, user interface skin, brightness of a device, or away from office notifications, among many others. For example, as a location enabled PDA enters a hospital zone, the PDA can power down to comply with hospital policy that electronic devices be turned off to prevent interference with hospital instrumentation. Installing software can occur with or without user interaction. For example, where a particular high resolution medical instrumentation catalog has been downloaded based in part on visiting an oncologist's office, the catalog can be made available for viewing on a location enabled PDA without further interaction by the user. Further, for example, where the catalog has an imbedded software application, the user can be queried before the software is installed for execution on the location enabled PDA.

In another aspect, location aware devices and/or systems can seek updates based on location based factors to facilitate location optimization in accordance with an aspect of the subject matter. Location factors can be defined in zones, for example, tax rule updates can be based on county location zones, state location zones, or country location zones. For example, a tax rule update can include discrete zone information, such as, “state sales tax=0.082”. Further, for example, a tax rule update can include layered zone information, such as, “state sales tax =0.082, county sales tax =0.009, and municipality hotel tax=0.010”, resulting in a determination that staying in a hotel in that state, county, and city would be taxed at a rate of 0.101 while staying in that state and county but in a different city would be taxed at a rate of 0.091.

Moreover, in addition to zone updates being used alone or in combination, zone updates can be anticipatory. Anticipatory zone updates can occur where a device/system is determined to be in a condition where a next zone update can be relevant. For example, where a user with a location enabled PDA is travelling towards another zone, such as approaching the border between the U.S. and Canada from the U.S. side, it can be determined or an inference can be determined that the Canadian zone update can be relevant. As such, the Canadian zone updates can be sought, downloaded, and made available even before the user's PDA crosses into the Canadian zone.

Alternatively, zone edges can be considered fuzzy, meaning that determinations can be made that as zone centers are approached (e.g., going towards the center of a new zone) related updates can become more relevant and as zone centers are retreated from (e.g., going away from a zone center) related updates can become less relevant. Under this approach, as a user with a location enabled PDA is travelling toward Cleveland from Seattle, as the user and PDA get closer to the Cleveland zone center the Cleveland related updates can become more relevant and the Seattle related updates can become less relevant because the user and PDA are also travelling away from the Seattle zone center.

In another aspect, a location enabled device and/or system can employ inferences to facilitate developing determinations about location zone transition behavior. Contextual information can be harnessed to allow inferences to be determined that can be used to further optimize the location aware system or device. For example, as a user and location enabled PDA travel a regular commute home in the evening after work, the location enabled device can determine that the PDA is transitioning from the city location zone to the suburb location zone. Further, an inference can be made that the transition will occur based on, for example, the time of day, the day of the week, and the amount of use the PDA is getting, among others. Moreover, further inferences can be made based, for example, on commute history, among others, that the user will not stop by the local theater on the way home in the evening. Thus, even though the user may transition through a theater location zone, such zone relevance can be reduced by the inferential determination that the user is likely to bypass the theater location zone to get home to the user's family. Thus, the inference can be employed to further optimize location zone transitions. Inferences can be based on, for example, weather, lighting conditions, time of day, day of week, user identity, location, number of location zones, types of location zones, historical use of the device or system, historic user interactions, historical use of the zone updates, or combinations thereof, among many others. One of skill in the art will appreciate that there are nearly a limitless number of inputs to a location zone inferential system and that all of these are considered within the scope of the subject innovation.

The subject innovation is hereinafter illustrated with respect to one or more arbitrary architectures for performing the disclosed subject matter. However, it will be appreciated by one of skill in the art that one or more aspects of the subject innovation can be employed in other memory system architectures and is not limited to the examples herein presented.

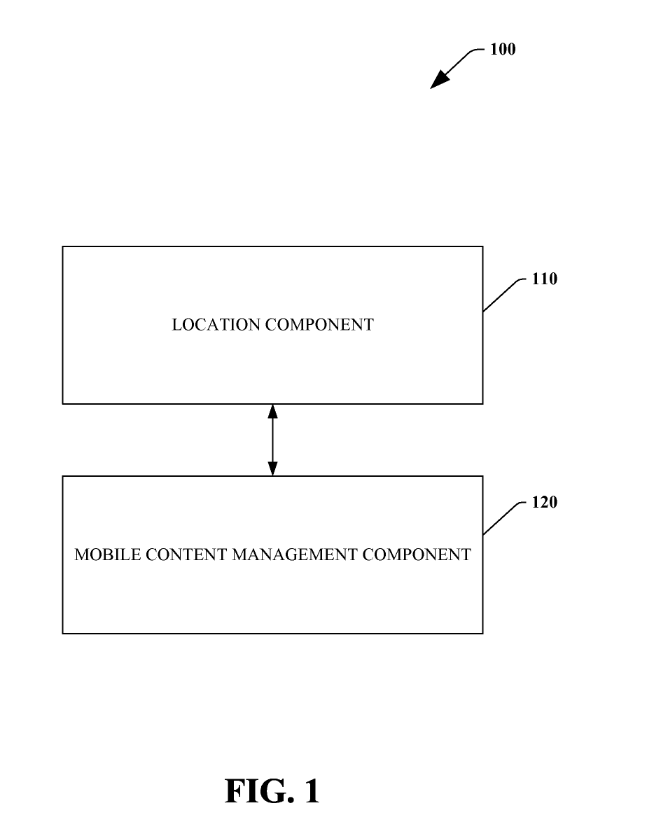

Turning to FIG. 1, illustrated is a system 100 that can facilitate location optimization in accordance with an aspect of the subject matter disclosed herein. System 100 can include a location component 110 to facilitate location and transition determinations. The location component 110 can include capabilities for determining the location of a device and/or system in relation to location zones. For example, the location component can determine device/system location by employing GPS signals, triangulation by cellular tower signals, monitoring Wi-Fi or other intra/internet signals, inertial tracking information, inferential determinations, or combinations thereof, among others as disclosed herein. Thus, for example, a cellular phone can determine the location of the phone by triangulating the position from local cell towers and, for example, if cell signal is lost, can continue determining location based on inertial tracking.

Further, the location component 100 can determine the location zone nature of a device and/or system that is location enabled. For example, where a location enabled cell phone determines its location to be in Seattle and moving, that movement can be analyzed to aid in determining possible location zone transitions, for example, movement towards Bellevue can be employed in determining that the Bellevue location zone can be a location zone transition candidate. Further, inferences can be determined based in part on the movement. For example, where the cell phone is moving from Seattle towards Bellevue, an inference can be made that the cell phone can inclusively be transitioning to the Bellevue location zone, the Redmond location zone, and the Microsoft campus location zone. These inferences and determinations can be employed by system 100 to facilitate location optimization in accordance with an aspect of the subject matter.

In an aspect, system 100 can include a mobile content management component (MCMC) 120 to further facilitate location optimization in accordance with an aspect of the subject matter. The MCMC 120 can facilitate location optimization by seeking relevant updates based in part on determinations made about current location and/or location zone transitions. These updates can include software updates and data updates as discussed herein.

For example, where a cell phone is located in Seattle and is moving towards Bellevue and an inference has been determined that the Microsoft campus can be a destination, the MCMC 120 can seek updates related to the Seattle location zone (e.g., the zone the device is currently in), the Bellevue and Redmond location zones (e.g., zone that are expected to entered) and the Microsoft campus location zone (e.g., an expected destination zone). The relevant updates located can then be evaluated, downloaded, and made available to the user through the MCMC 120.

In this example, the relevant Seattle zone updates can, for example, include updates such as traffic information for Interstate 5 between downtown Seattle and highway 520, the locations of fuel stations before the freeway is entered, and to do items that are related to travel in that direction based in part on the users calendar stored in the cell phone, among others. Further, the relevant Bellevue and Redmond location zone updates can include, for example, traffic information for highway 520 between Interstate 5 and highway 202, among others. The relevant Microsoft campus location zone update can include, for example, a copy of a presentation to be given to a software manager, a special preferred customer pricing guideline module, and a list of highly rated coffee shops near the Microsoft campus, among others. Thus, where the user is still located in Seattle and travelling towards Bellevue, the location enabled device can make determinations and inferences to facilitate seeking relevant updates based in part on expected location zone transitions to facilitate location optimization.

Further, as the location and movement evolve, the system 100 can continue to seek relevant updates based in part on determinations and/or inferences. Continuing the above example, as the user travels through Bellevue, a traffic accident ahead can result in serious delays. The location aware device can determine that due to the bad traffic, alternate route map update information can be relevant. The location aware device can therefore, for example, seek relevant traffic and road map updates and present those to the device user. Where the device user, for example, takes an alternate route, relevant location zone information can be sought by the location aware device, such as, gas stations in the area, among others.

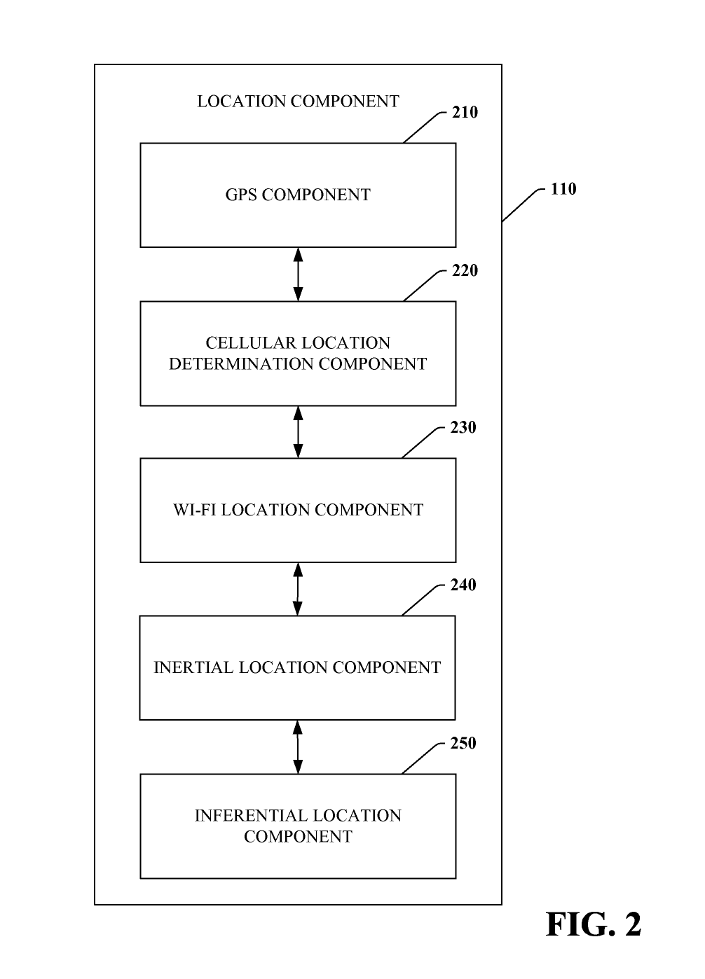

Referring now to FIG. 2, illustrated is a location component 110 that can facilitate location optimization in accordance with an aspect of the subject matter disclosed herein. The location component 110 can facilitate determinations of the current device/system location and/or potential location zone transitions as described herein. The location component 110 can include a GPS component 210 to facilitate determining the current location based in part on GPS signals. The location component 110 can also include a cellular location determination component 220 that can facilitate determining the current location based in part on cellular phone tower signals. For example the cellular location determination component 220 can determine a location by triangulating signals from a plurality of cell tower signals.

Further, the location component 110 can include a Wi-Fi location component 230 to facilitate determining the current location based in part on Wi-Fi signals. The Wi-Fi location component 230 can further determine current location based on other internet and/or intranet signals. For example, where each floor in a building has a separate Wi-Fi net, each net can be identified and related to the particular floor it services. Based on this relationship, a location aware device having a Wi-Fi location component 230 can determine with floor granularity the current position in the building.

The location component 110 can further include an inertial location component 240 to facilitate determining a current location. Modern inertial tracking is sophisticated and effective. By tracking changes in the inertia of a device/system with, for example, accelerometer chips, the path traveled can be effectively determined. Thus, for example, where a location enabled device begins at a known position, for example, by triangulating a position based on cellular signals, the changes in the inertia of the device can be monitored to determine a new position even where, for example, the cellular signal has been lost. This can be effective, for example, where a location enabled device is in a tunnel or in an area with many high buildings that can complicate cellular triangulation or GPS signal reception, among others.

The location component 110 can further include an inferential location component 250 to facilitate determining a current location. The inferential component can make determinations based on many factors as herein discussed at length. These factors can be employed to determine the likely location of a device. For example, where it is 4 am and the location enabled device is resting in a charging cradle, it can be inferred, based on these factors, among others, that the device is located on the bedside table of the user at home. In another example, where the user regularly drives through a tunnel on the way to work, a location enabled device can infer that the device is in the tunnel when the last GPS location was near the tunnel entrance, the time is 7:30 am, and the direction of travel is towards the user's office. It can further be inferred that the user will exit the tunnel at a known location. Therefore inferences can facilitate location optimization in accordance with an aspect of the subject matter disclosed herein.

The components included in the location component 110 can be communicatively coupled to provide data and determinations therebetween. For example, GPS location component 210 can communicate location information to the inferential location component 250 to facilitate determining location inferences where the GPS signals are interrupted. In another example, cellular triangulation data can be communicated to the GPS component 210 to facilitate faster acquisition of relevant GPS signals.

Moreover, the location component 110 can include components for determining and/or inferring location zone transitions (not illustrated) as discussed herein. Determinations and/or inferences of location zone transitions can be based in part on the current location determinations and/or current location inferences as discussed herein. Location zone transitions can be only a function of current location (e.g., current location only determines what updates are sought), can be a function of current location and neighboring location zones (e.g., a first location can be near a plurality of other locations that can have relevant updates available), can be a function of overlapping location zones (e.g., a location can have multiple layers of overlapping zone information such as gas station information, historical monument information, traffic information, weather information, emergency information, telephone information, schedule information, . . . ), can be functions of inferred or determined transition location zones (e.g., zones to be transitioned along a deterministic route can be determined or inferred), or combinations thereof, among others.

Location and transition zone information can be employed to facilitate location optimization in accordance with an aspect of the subject matter disclosed herein. For example, such information can be communicated to a MCMC 120 (see FIG. 1) for determination of relevant updates.

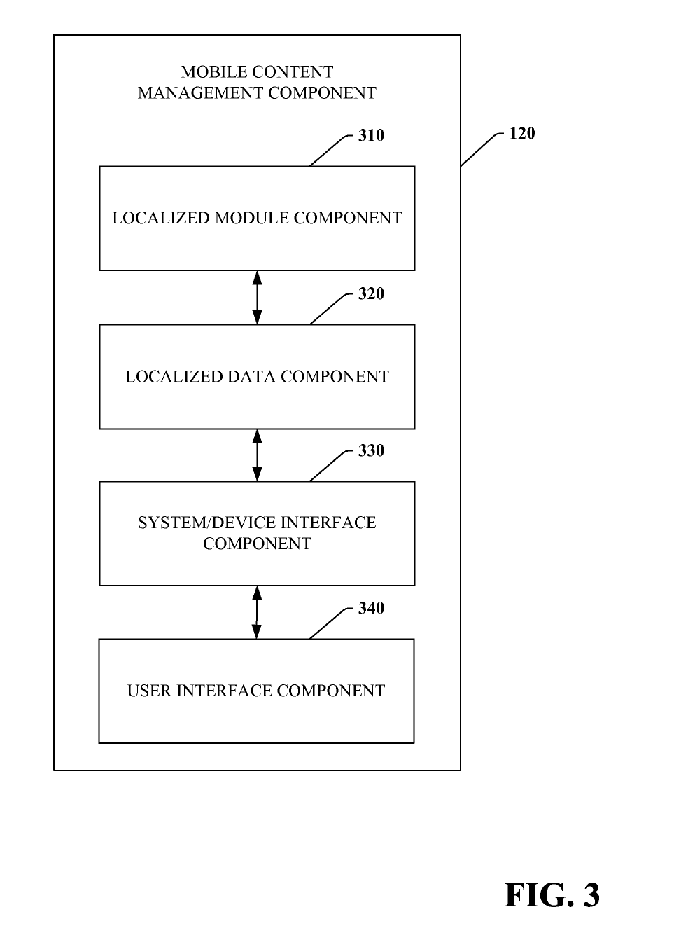

Referring now to FIG. 3, illustrated is mobile content management component (MCMC) 120 that can facilitate location optimization in accordance with an aspect of the subject matter disclosed herein. The MCMC 120 can include a localized module component 310 that can facilitate software content management. The localized module component 310 can aid in determining the relevance of available updates based in part on location and transition zone information provided by the location component 110 (see FIGS. 1 and 2) as discussed herein. For example, where it is determined that a location aware PDA carried by a sales person is entering a foreign customer's office, a presentation in the local language can be determined to be relevant. The localized sales presentation can be downloaded and made available to the user for presentation to the client at a sales meeting.

Further, the MCMC 120 can include a localized data component 320 that can facilitate data content management. Management of data can include determinations of the relevance of such data. For example, traffic and weather data for a road the user is travelling with a location aware cell phone can be determined to be relevant whereas fuel station data can be considered irrelevant where the user has recently left a fueling station. As another example, as a user enters a new city with a location aware GPS device, local movie show times, local restaurant ratings, local hotel rates, and local fuel station prices can be updated while local opera information can be irrelevant where a user has previously indicated that opera is not of interest. Numerous other data content can be managed by the localized data component 320 as discussed herein.

The MCMC 120 can also include a system/device interface component 330 and/or a user interface component 340 to facilitate interacting with the user and or device/system. For example, where relevant updates indicate that, for example, a cell phone ring should be set to silent, this can be facilitated through the system/device interface component 330. The user interface component 340 can facilitate, for example, a user verification that a relevant software update should be installed, user preferences, or user selection of pertinent data updates, among many others.

The included components of the MCMC 120 can be communicatively coupled. For example, where a relevant software update has been downloaded through the localized module component 310, the user can be queried as to installation of the download through the user interface component 340. Further the MCMC 120 can be communicatively coupled to the location component 110 as illustrated in FIG. 1 to facilitate location optimization in accordance with an aspect of the subject matter disclosed herein.

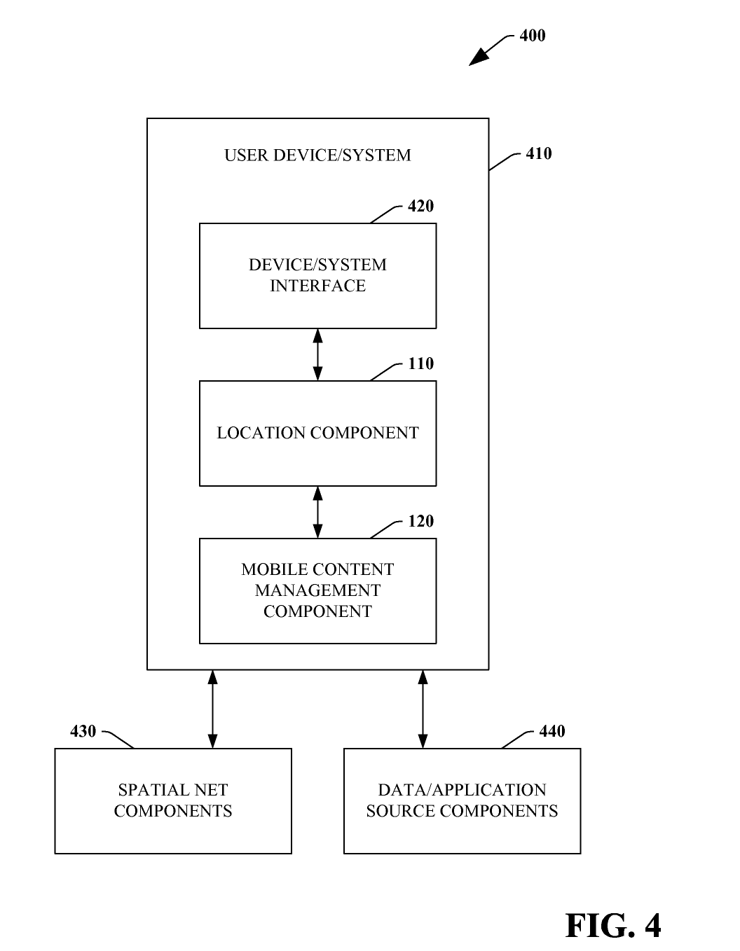

Referring now to FIG. 4, illustrated is a diagram of a system 400 employing location awareness that can facilitate location optimization in accordance with an aspect of the disclosed subject matter. The user device/system 410 can include a device/system interface 420 that can facilitate employing a location component 110 and MCMC 120 (e.g., system 100) in a location aware device and/or system. For example, the device/system interface 420 can be a software API.

The user device/system 410 can be selectively communicatively coupled to spatial net components 430 to facilitate location optimization. Spatial net components 430 can be, for example, GPS signal producers (e.g., geosynchronous GPS satellites), cell phone towers, other electronic devices and/or systems (e.g., in an ad hoc network, among others), or combinations thereof, among others. For example, where the user device/system 410 is a location enabled cell phone, the spatial net components 430 can be cell phone towers facilitating triangulation of the location of the cell phone.

The user device/system 410 can be selectively communicatively coupled to data/application source components 440 to facilitate location optimization. Data/application source components 440 can be, for example, remote servers or other devices/systems (e.g., in an ad hoc network, among others) among others. Communication with the data/application source components 440 can be by any communication method amenable to the transfer of relevant data and/or applications to the user device/system 410. For example, where the user device/system is a location enabled PDA, the data/application source components 440 can be, for example, a corporate level server (e.g., to facilitate downloading of locally relevant sales contacts, among others), a traffic information server (e.g., to download locally relevant traffic information), or a new service server (e.g., to download locally relevant news information), among many others. One of skill in the art will appreciate that the sources of data and/or applications are nearly limitless and that all such sources of locally relevant data and/or applications are within the scope of the subject innovation.

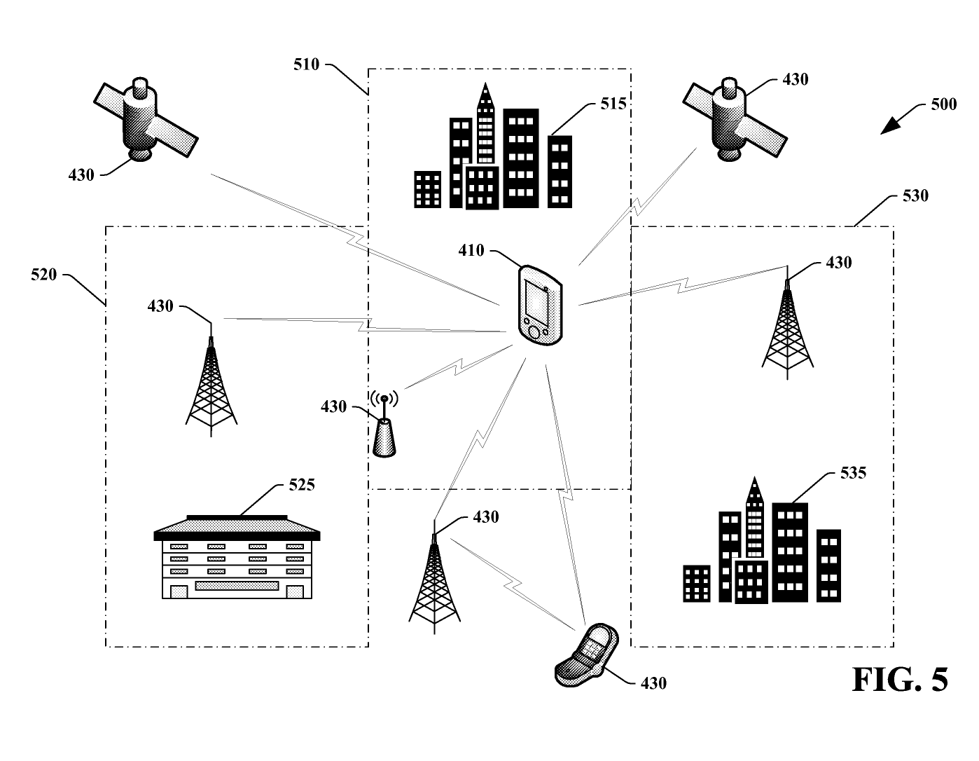

Referring now to FIG. 5, a schematic illustration of a system to facilitate location optimization in accordance with an aspect of the disclosed subject matter is depicted. A location enabled user device 410 can be communicatively coupled to a plurality of spatial net components 430. Further, location specific information can be accessed based in part on the location zones 510, 520, and 530. For example, location zone 510 can encompass metropolitan area 515. Where device 410 is located in the same location zone as area 515, data and applications relevant to area 515 can be sought, downloaded, and enabled. Further, as device 410 moves towards another zone (e.g., 520 or 530), anticipatory determinations and/or inferences can be made as to the relevance of data and/or applications related to those other location zones (e.g., 520 and 530). For example, where device 410 moves towards customer location 525 in location zone 520, it can be determine that data and applications related to the transition from location zone 510 to location zone 520 are relevant such that these data and applications can be sought, downloaded, and enabled for the user of device 410. Similarly, as device 410 moves toward metropolitan area 535 in location zone 530, it can be determined that data and applications related to location zone 530 are relevant and this data and/or applications can be sought, downloaded, and enabled.

Additionally, where granularity is sufficiently fine, relevant data can be determined or inferred not only for generalized location zones 510, 520, and 530, but also for the more granular location zones of metropolitan area 515, customer location 525, and metropolitan area 535. Thus, for example, transitions from location zone 510 towards customer location 525 can include relevant updates related to location zone 520 and relevant updates related to customer location 525. Similarly, transitions from customer location 525 to metropolitan area 535 can include relevant updates for the transition from customer location 525 to location zone 520, from location zone 520 to location zone 510, from location zone 510 to location zone 530, and from location zone 530 to metropolitan zone 535, among others.

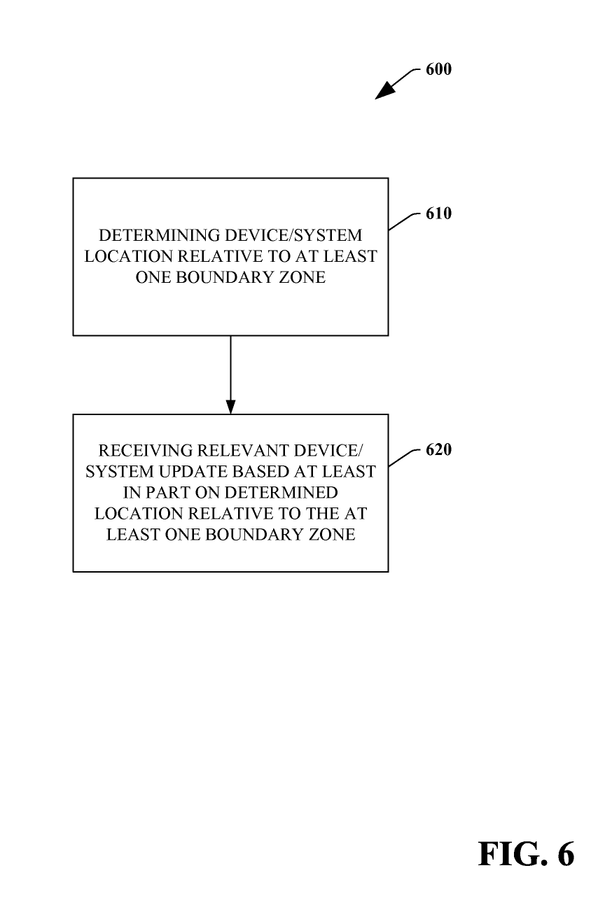

FIGS. 6-9 illustrate methodologies, flow diagrams, and/or timing diagrams in accordance with the disclosed subject matter. It is to be appreciated that the methodologies presented herein can incorporate actions pertaining to a neural network, an expert system, a fuzzy logic system, and/or a data fusion component, or a combination of these, which can generate diagnostics indicative of the optimization of proximity based information acquisition operations germane to the disclosed methodologies. Further, the prognostic analysis of this data can serve to better optimize proximity based information acquisition operations, and can be based on real time acquired data or historical data within a methodology or from components related to a methodology herein disclosed, among others. It is to be appreciated that the subject invention can employ highly sophisticated diagnostic and prognostic data gathering, generation and analysis techniques, and such should not be confused with trivial techniques (e.g., anticipating a location zone transition where a user is on a highway with no exits before the new location zone is entered).

For simplicity of explanation, the methodologies are depicted and described as a series of acts. It is to be understood and appreciated that the subject innovation is not limited by the acts illustrated and/or by the order of acts, for example acts can occur in various orders and/or concurrently, and with other acts not presented and described herein. Furthermore, not all illustrated acts may be required to implement the methodologies in accordance with the disclosed subject matter. In addition, those skilled in the art will understand and appreciate that the methodologies could alternatively be represented as a series of interrelated states by way of a state diagram or events. Additionally, it should be further appreciated that the methodologies disclosed hereinafter and throughout this specification are capable of being stored on an article of manufacture to facilitate transporting and transferring such methodologies to computers. The term article of manufacture, as used herein, is intended to encompass a computer program accessible from any computer-readable device, carrier, or media.

Referring now to FIG. 6, illustrated is a methodology 600 that facilitates location optimization in accordance with an aspect of the disclosed subject matter. Conventional methodologies frequently do not provide rich device and/or system location based updates. For example, conventional methodologies for updating the time on a cellular phone employ the cell phone adopting a time based on the time stamp of the broadcasting cellular phone tower. This technique can frequently result in the correct time being updated on the cell phone but can also result in incorrect times being displayed on the cell phone, particularly when the cell phone and tower are on different sides of a time zone (e.g., PST/MST; MST/CST; CST/EST, among others). This is because the location of the cell phone itself is not the basis of the time update, rather the location of the tower is the basis of the update and any device within the broadcast range can be affected similarly.

The methodology 600 can facilitate location optimization by basing, at least in part, device/system updates on a granular determination of the location of the device and/or system. At 610, methodology 600 can determine the granular location of a device/system. This can be done relative to at least one boundary zone, such as a location zone. For example, a city location zone can be determined for a location enabled cell phone located within the city comprising the city location zone, among many other examples as discussed herein.

At 620, methodology 600 can receive relevant device/system updates based at least in part on the determined location to facilitate location optimization. For example, a pricing file module update that is relative to entering sales at a customer location can be received by a location enabled PDA in response to the determination that it is located at the customer site. At this point, methodology 600 can end.

In an aspect of the disclosed invention, the determinations made at 610 can further be employed to determine location zone transitions. By, for example, determining a series of consecutive locations, a direction of movement can be determined and compared against other location zones in the direction of travel. Further, actual motion tracking (e.g., where a device contains an inertial tracking component 240) can be used, for example, by monitoring the actual accelerations of the location enabled device to aid in determining location zone transitions as discussed herein.

In another aspect, the determined location and any derived movement determinations can be employed in determining relevant updates. By seeking updates that are relevant to the particular location and/or particular location zone transitions, a location enabled device/system can find information specifically related to the location of the device/system. Further, the granularity of the information can be different than the granularity of the location or zone transition determinations as discussed herein. For example, it can be determined that a neighborhood zone update (e.g., neighborhood granularity) is relevant for updating movie times to a device that has determined a location to a street address in that neighborhood (e.g., address granularity). Further, in the example, it can be determined that a national emergency update is relevant (e.g., national granularity) where the cell phone (e.g., still at address granularity) is also located near a boarder with the country experiencing the national emergency (e.g., the cell phone can be located on the U.S. side, but near the Canadian border).

In another aspect, system 600 can download, install and make available the sought relevant updates. This can occur with or without user interaction. For example, a relevant client list update can be found, downloaded, and installed such that the next time the user opens the contact list in that location, the updated contacts are seamlessly available. In another example, a relevant update containing a large file can be located and the user can be queried prior to downloading the file based in part on the large size of the file. In a third example, a location specific software application can be determined to be relevant, the software can be downloaded and the user can be queried prior to installing the application. Numerous other examples of employing or not employing user interactions into the methodology are possible and all are considered within the scope of the subject innovation.

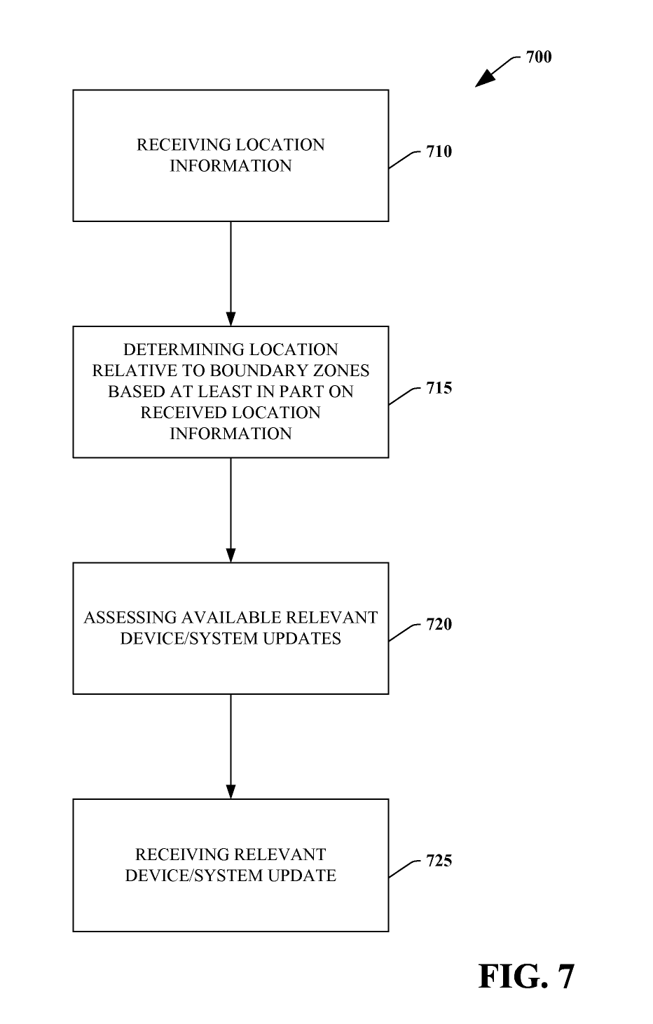

Referring now to FIG. 7, illustrated is a methodology 700 that facilitates location optimization in accordance with an aspect of the disclosed subject matter. At 710, methodology 700 can receive location information. For example, a GPS component 210 can provide GPS location information for the methodology 700. The location information can similarly be provided by, for example, a cellular location determination component 220, a Wi-Fi location component 230, an inertial location component 240, or an inferential location component 250, among others. At 715, the location information can be employed as part of a determination of the granular location of a system and/or device employing methodology 700. For example, GPS location information can be combined with inertial location information to determine that, for example, a location enabled cell phone is 700 feet into the Chunnel. Numerous other examples of employing location information in determining a location are possible, as disclosed herein among others, and all are considered within the scope of the disclosed subject matter. Further, at 715, the location information can also be employed to determine location relative to location zone transitions (e.g., boundary zone conditions). For example, where the cell phone can determine that it is 700 feet into the Chunnel, it can further be determined that the cell phone is moving from England towards France and therefore a transition from the England location zone to the France location zone is occurring.

At 720, the availability of relevant updates can be determined to facilitate location optimization. A location enabled device/system can use the determination of a location and/or location zone transition when seeking relevant updates. For example, transitioning from the England location zone to the France location zone can be used to determine that a French news source update is available and relevant. Similarly, this transition can be used to determine that a London train schedule update is available and irrelevant (e.g., because the device is heading towards France, it is unlikely that a London train schedule is relevant to the user).

At 725, the relevant updates can be received by the location aware device/system to facilitate location optimization. Where relevant updates are located, these updates can be seamlessly downloaded to the location aware device/system as herein described. For example, the French news source update can be downloaded while the user is travelling through the Chunnel on the way to France. In another example, where location information is passed to a remote source from the location enabled device, the search for relevant updates can result in an update being pushed back to the device. For example, the cell phone can provide the location (e.g., 700 feet into the Chunnel) to the user's corporate server. The server can analyze the location and determine that a French localized software module is relevant. This module can then be pushed to the cell phone from the corporate server and received by the cell phone at 725. After this, method 700 can end.

As described herein, gathering location information, determining a location and location zone transitions, seeking relevant updates based on the location and/or transitions, and receiving relevant updates, can include inferential analysis. This inferential analysis can be based on numerous factors as disclosed herein. Further, the inferential analysis can relate to the location, location zone transitions, relevance of location updates, and/or download and/or installation of updates, among others. For example, an inference can be made that the cell phone user is located in the Chunnel based in part on the last GPS signal received at the entrance to the Chunnel; an inference can be made that the user is travelling towards France based in part on the direction of travel prior to entering the Chunnel; an inference can be made that a French news source update is relevant based in part on the user's prior history of reading such news updates; and an inference can be made that the news update can be downloaded and installed based in part on the user's preference settings and history of reading such news updates. Thus, the user can experience a seamless news update as a result of inferential determinations that facilitate location optimization. Numerous other inferences can be made, as described herein, and all such inferential determinations are considered within the scope of the disclosed subject matter.

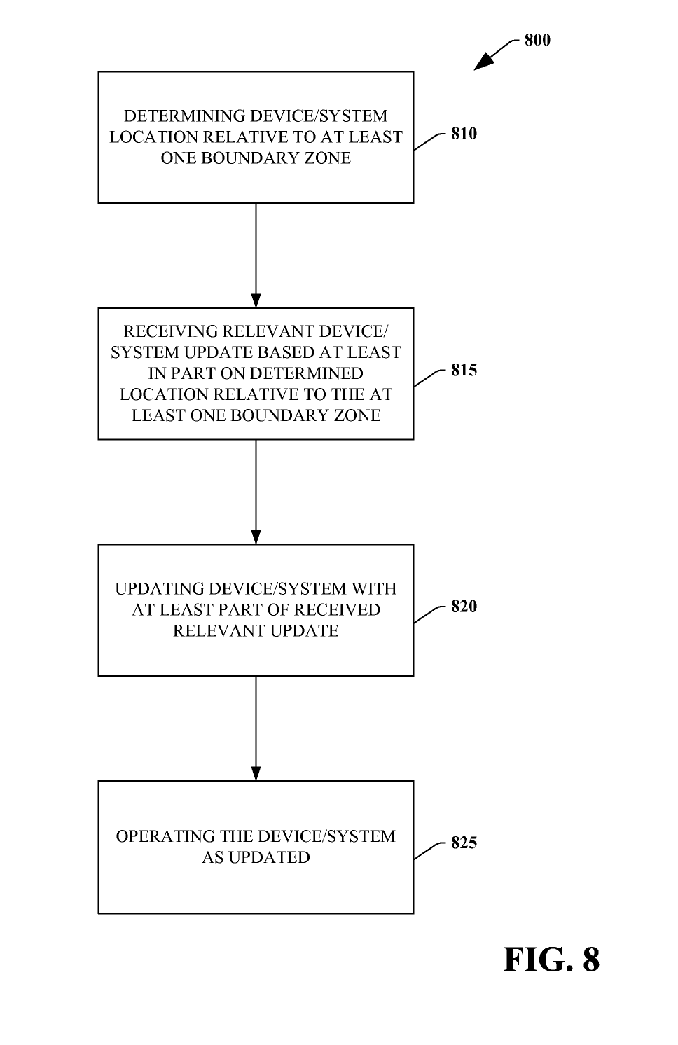

Referring now to FIG. 8, illustrated is a methodology 800 that facilitates location optimization in accordance with an aspect of the disclosed subject matter. At 810 a determination of the device location and/or location zone transitions can be made as described herein at length. At 815, relevant updates can be sought and downloaded as also described herein.

At 820, the device/system can be updated with at least part of the downloaded relevant update to facilitate location optimization. For example, where a relevant update includes both a software module and a news source update, the news source update can be installed while the software module can be quarantined until a user gives permission to install the module. Further, for example, where the module can have a timestamp, for example, relative to the recency of the update, it can be determined that an existing module is more current and the downloaded module can be abandoned or quarantined in favor of the already installed module. The updating of the device/system at 820 can be based on determinations and/or inferences local to the device/system. For example, where update relevance is determined on a remote server and an update is received by a location aware device/system, the device/system can then locally determine the appropriateness of installing the received update.

At 825, an update that has been received and at least in part used to update the device can be made available to the user to facilitate location optimization. Where a portion of an update has been installed, the portion of the update can be made available to the user through device/system operation. For example, where the news update has been downloaded and installed but the software module has only been downloaded and quarantined, the news update can be made available to the device/system user under operation of the device/system, for example, when the user selects a “local news” icon on the device/system user interface. After this, method 800 can end.

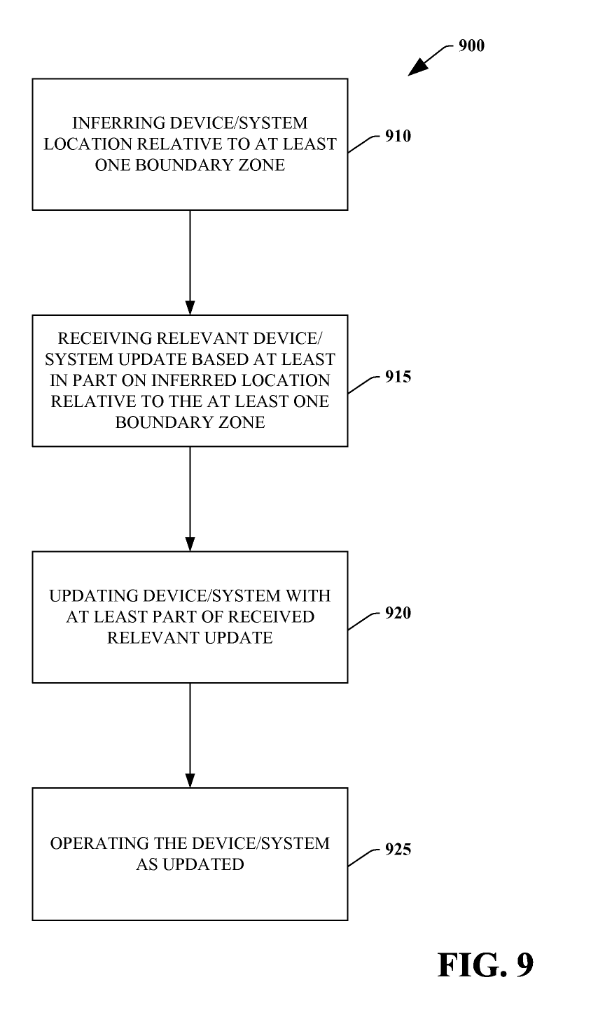

Referring now to FIG. 9, illustrated is a methodology 900 that facilitates location optimization in accordance with an aspect of the disclosed subject matter. At 910, an inference about the device location and/or location zone transitions can be made as described herein. For example, a location enabled device/system, such as a PDA, can infer that it is located in an airplane over the Midwest and traveling towards Boston based on, for example, a last GPS location of Portland, Oreg., travelling at a high rate of speed (e.g., airliner flying at 500 mph), and the user's schedule data indicating a flight to Boston at about the current time, among others. At 915, relevant updates can be sought and downloaded as also described herein, based at least in part on the location and/or location zone transition inferences. For example, where it has been inferred that the user and the device/system are travelling to Boston, updates related to the Midwest can be determined to be irrelevant because it is unlikely that the user and device/system will stop in the Midwest while in an airplane at 30,000 feet. Similarly, it can be determined that Boston related updates can be relevant such that those updates are downloaded by the exemplary location enabled PDA.

At 920, the device/system can be updated with at least a part of the relevant update received by the device/system as described herein. At 925, the device/system can make the installed portions of the update available to the device/system user, also as described herein. For example, where inferences have been employed to determine locations and/or location zone transitions, and these inferences have been employed as part of a determination of relevance of available updates, the received updates can be at least in part installed and made available to the device/system user. For example, where an inference has been made that a location zone transition to Boston can occur, an East coast pricing module, for instance, can be downloaded to the PDA and can be installed and made available to the user through, for example, a currently installed sales software package. After this, method 900 can end.

It is to be appreciated that more complex inferential determinations can be made regarding device location and/or location zone transitions, relevance of updates, installation of at least a portion of an update, and/or what portions of installed updates to make available to the user, as discussed herein. It is to be further appreciated that further inferences and determinations can be based at least in part on these initial location and/or location zone transition inferential determinations as also discussed at length herein. All such modifications of method 900 are considered to be within the scope of the disclosed subject matter.

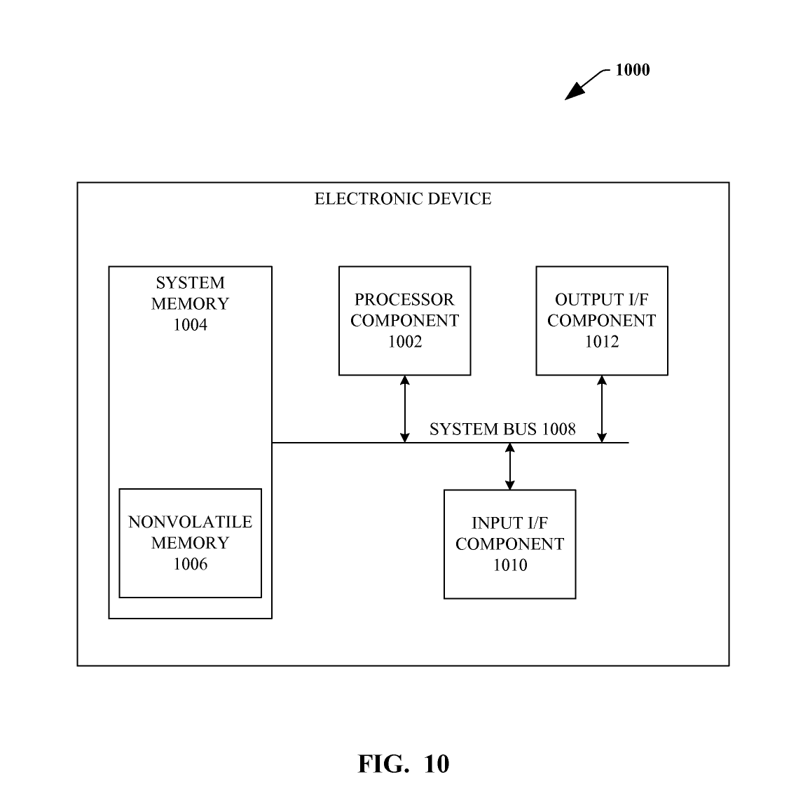

Referring to FIG. 10, illustrated is a block diagram of an exemplary, non-limiting electronic device 1000 that can facilitate location optimization in accordance with one aspect of the disclosed subject matter. The electronic device 1000 can include, but is not limited to, a computer, a laptop computer, barcode scanners, optical scanners, network equipment (e.g. routers, access points), a media player and/or recorder (e.g., audio player and/or recorder, video player and/or recorder), a television, a smart card, a phone, a cellular phone, a smart phone, an electronic organizer, a PDA, a portable email reader, a digital camera, an electronic game (e.g., video game), an electronic device associated with digital rights management, a Personal Computer Memory Card International Association (PCMCIA) card, a trusted platform module (TPM), a Hardware Security Module (HSM), set-top boxes, a digital video recorder, a gaming console, a navigation system (e.g., global position satellite (GPS) system), secure memory devices with computational capabilities, devices with tamper-resistant chips, an electronic device associated with an industrial control system, an embedded computer in a machine (e.g., an airplane, a copier, a motor vehicle, a microwave oven), and the like.

Components of the electronic device 1000 can include, but are not limited to, a processor component 1002, a system memory 1004 (with nonvolatile memory 1006), and a system bus 1008 that can couple various system components including the system memory 1004 to the processor component 1002. The system bus 1008 can be any of various types of bus structures including a memory bus or memory controller, a peripheral bus, or a local bus using any of a variety of bus architectures.

Electronic device 1000 can typically include a variety of computer readable media. Computer readable media can be any available media that can be accessed by the electronic device 1000. By way of example, and not limitation, computer readable media can comprise computer storage media and communication media. Computer storage media can include volatile, non-volatile, removable, and non-removable media that can be implemented in any method or technology for storage of information, such as computer readable instructions, data structures, program modules or other data. Computer storage media includes, but is not limited to, RAM, ROM, EEPROM, nonvolatile memory 1006 (e.g., flash memory), or other memory technology, CD-ROM, digital versatile disks (DVD) or other optical disk storage, magnetic cassettes, magnetic tape, magnetic disk storage or other magnetic storage devices, or any other medium which can be used to store the desired information and which can be accessed by electronic device 1000. Communication media typically can embody computer readable instructions, data structures, program modules or other data in a modulated data signal such as a carrier wave or other transport mechanism and includes any information delivery media.

The system memory 1004 can include computer storage media in the form of volatile and/or nonvolatile memory 1006. A basic input/output system (BIOS), containing the basic routines that help to transfer information between elements within electronic device 1000, such as during start-up, can be stored in memory 1004. Memory 1004 can typically contain data and/or program modules that can be immediately accessible to and/or presently be operated on by processor component 1002. By way of example, and not limitation, system memory 1004 can also include an operating system, application programs, other program modules, and program data.

The nonvolatile memory 1006 can be removable or non-removable. For example, the nonvolatile memory 1006 can be in the form of a removable memory card or a USB flash drive. In accordance with one aspect, the nonvolatile memory 1006 can include flash memory (e.g., single-bit flash memory, multi-bit flash memory), ROM, PROM, EPROM, EEPROM, or NVRAM (e.g., FeRAM), or a combination thereof, for example. Further, the flash memory can be comprised of NOR flash memory and/or NAND flash memory.

A user can enter commands and information into the electronic device 1000 through input devices (not shown) such as a keypad, function buttons, trigger, microphone, graphical user interface, tablet or touch screen although other input devices can also be utilized. These and other input devices can be connected to the processor component 1002 through input interface component 1012 that can be connected to the system bus 1008. Other interface and bus structures, such as a parallel port, game port or a universal serial bus (USB) can also be utilized. A graphics subsystem (not shown) can also be connected to the system bus 1008. A display device (not shown) can be also connected to the system bus 1008 via an interface, such as output interface component 1012, which can in turn communicate with video memory. In addition to a display, the electronic device 1000 can also include other peripheral output devices such as speakers (not shown), which can be connected through output interface component 1012.

It is to be understood and appreciated that the computer-implemented programs and software can be implemented within a standard computer architecture. While some aspects of the disclosure have been described above in the general context of computer-executable instructions that may run on one or more computers, those skilled in the art will recognize that the technology also can be implemented in combination with other program modules and/or as a combination of hardware and software.

Generally, program modules include routines, programs, components, data structures, etc., that perform particular tasks or implement particular abstract data types. Moreover, those skilled in the art will appreciate that the inventive methods can be practiced with other computer system configurations, including single-processor or multiprocessor computer systems, minicomputers, mainframe computers, as well as personal computers, hand-held computing devices (e.g., PDA, phone), microprocessor-based or programmable consumer electronics, and the like, each of which can be operatively coupled to one or more associated devices.

The illustrated aspects of the disclosure may also be practiced in distributed computing environments where certain tasks are performed by remote processing devices that are linked through a communications network. In a distributed computing environment, program modules can be located in both local and remote memory storage devices.

As utilized herein, terms “component,” “system,” “interface,” and the like, can refer to a computer-related entity, either hardware, software (e.g., in execution), and/or firmware. For example, a component can be, but is not limited to being, a process running on a processor, a processor, a circuit, a collection of circuits, an object, an executable, a thread of execution, a program, and/or a computer. By way of illustration, both an application running on a server and the server can be a component. One or more components can reside within a process and a component can be localized on one computer and/or distributed between two or more computers.

The disclosed subject matter can be implemented as a method, apparatus, or article of manufacture using standard programming and/or engineering techniques to produce software, firmware, hardware, or any combination thereof to control a computer to implement the disclosed subject matter. The term “article of manufacture” as used herein is intended to encompass a computer program accessible from any computer-readable device, carrier, or media. For example, computer readable media can include but are not limited to magnetic storage devices (e.g., hard disk, floppy disk, magnetic strips . . . ), optical disks (e.g., compact disk (CD), digital versatile disk (DVD) . . . ), smart cards, and flash memory devices (e.g., card, stick, key drive . . . ). Additionally it should be appreciated that a carrier wave can be employed to carry computer-readable electronic data such as those used in transmitting and receiving electronic mail or in accessing a network such as the Internet or a local area network (LAN). Of course, those skilled in the art will recognize many modifications can be made to this configuration without departing from the scope or spirit of the disclosed subject matter.

Some portions of the detailed description have been presented in terms of algorithms and/or symbolic representations of operations on data bits within a computer memory. These algorithmic descriptions and/or representations are the means employed by those cognizant in the art to most effectively convey the substance of their work to others equally skilled. An algorithm is here, generally, conceived to be a self-consistent sequence of acts leading to a desired result. The acts are those requiring physical manipulations of physical quantities. Typically, though not necessarily, these quantities take the form of electrical and/or magnetic signals capable of being stored, transferred, combined, compared, and/or otherwise manipulated.

It has proven convenient at times, principally for reasons of common usage, to refer to these signals as bits, values, elements, symbols, characters, terms, numbers, or the like. It should be borne in mind, however, that all of these and similar terms are to be associated with the appropriate physical quantities and are merely convenient labels applied to these quantities. Unless specifically stated otherwise as apparent from the foregoing discussion, it is appreciated that throughout the disclosed subject matter, discussions utilizing terms such as processing, computing, calculating, determining, and/or displaying, and the like, refer to the action and processes of computer systems, and/or similar consumer and/or industrial electronic devices and/or machines, that manipulate and/or transform data represented as physical (electrical and/or electronic) quantities within the computer's and/or machine's registers and memories into other data similarly represented as physical quantities within the machine and/or computer system memories or registers or other such information storage, transmission and/or display devices.

### Artificial Intelligence

Artificial intelligence based systems (e.g., explicitly and/or implicitly trained classifiers) can be employed in connection with performing inference and/or probabilistic determinations and/or statistical-based determinations as in accordance with one or more aspects of the disclosed subject matter as described herein. As used herein, the term “inference,” “infer” or variations in form thereof refers generally to the process of reasoning about or inferring states of the system, environment, and/or user from a set of observations as captured through events and/or data. Inference can be employed to identify a specific context or action, or can generate a probability distribution over states, for example. The inference can be probabilistic—that is, the computation of a probability distribution over states of interest based on a consideration of data and events. Inference can also refer to techniques employed for composing higher-level events from a set of events and/or data. Such inference results in the construction of new events or actions from a set of observed events and/or stored event data, whether or not the events are correlated in close temporal proximity, and whether the events and data come from one or several event and data sources. Various classification schemes and/or systems (e.g., support vector machines, neural networks, expert systems, Bayesian belief networks, fuzzy logic, data fusion engines . . . ) can be employed in connection with performing automatic and/or inferred action in connection with the disclosed subject matter.

For example, an artificial intelligence based system can evaluate current or historical evidence associated with data access patterns (e.g., use or abandonment of prior location aware updates, software accessed at particular locations, regular user travel routes, user interactions, environmental data (e.g., determining location, weather, time of day, . . . ), or combinations thereof, among others, . . . ) and based in part in such evaluation, can render an inference, based in part on probability, regarding, for instance, “the user does not stop for a movie on the way home from work, therefore movie updates for the local cinema can be irrelevant updates”, or “the user's wedding anniversary is tonight, therefore florists along a travel route can be relevant”, among many others. One of skill in the art will appreciate that intelligent and/or inferential systems can facilitate further optimization of the disclosed subject matter and such inferences can be based on a large plurality of data and variables all of with are considered within the scope of the subject innovation.

What has been described above includes examples of aspects of the disclosed subject matter. It is, of course, not possible to describe every conceivable combination of components or methodologies for purposes of describing the disclosed subject matter, but one of ordinary skill in the art will recognize that many further combinations and permutations of the disclosed subject matter are possible. Accordingly, the disclosed subject matter is intended to embrace all such alterations, modifications and variations that fall within the spirit and scope of the appended claims. Furthermore, to the extent that the terms “includes,” “has,” or “having,” or variations thereof, are used in either the detailed description or the claims, such terms are intended to be inclusive in a manner similar to the term “comprising” as “comprising” is interpreted when employed as a transitional word in a claim.

What is claimed is:

1. A system comprising:
a location component that determines at least a current device location, a location zone transition, or combination thereof, and
a mobile content management component that receives at least one relevant update based at least in part on the location component determination.

2. The system of claim 1, wherein the location component determines the at least a current device location, a location zone transition, or combination thereof, based at least in part on an inference about location information.

3. The system of claim 1, wherein the location component determination is made based at least in part on GPS information, cell phone system information, internet information, intranet information, ad hoc network information, inertial information, inferences about the location, or combinations thereof.

4. The system of claim 1, wherein the mobile content management component searchs for relevant updates based at least in part on the location component determination.

5. The system of claim 1, wherein the mobile content management component, as part of receiving at least one relevant update, downloads updates based at least in part on the location component determination.

6. The system of claim 5, wherein the mobile content management component update download is based at least in part on an update pushed from an external system.

7. The system of claim 1, wherein the mobile content management component download is at least one of compressed data, uncompressed data, compressed software code, uncompressed software code, compiled software code, uncompiled software code, portions of software code, audio files, video files, application program interface instructions, or combinations thereof and the like.

8. The system of claim 1, wherein the mobile content management component includes a system interface, a device interface, a user interface, or combinations thereof.

9. The system of claim 1, wherein the mobile content management component installs at least a portion of the received relevant update, makes available at least a portion of the received relevant update, or combinations thereof.

10. The system of claim 1, wherein the content management component makes inferences relating to the relevance of an update, at least portions of updates to download, at least portions of received updates to install, at least portions of received updates to make available, or combinations thereof, based at least in part on location information.

11. An electronic device comprising the system of claim 1.

12. The electronic device of claim 11, wherein the electronic device comprises at least one of a computer, a laptop computer, barcode reader, network equipment, a media player, a media recorder, a television, a smart card, a phone, a cellular phone, a smart phone, an electronic organizer, a personal digital assistant, a portable email reader, a digital camera, an electronic game, an electronic device associated with digital rights management, a Personal Computer Memory Card International Association (PCMCIA) card, a trusted platform module (TPM), a Hardware Security Module (HSM), set-top boxes, a digital video recorder, a gaming console, a navigation system, a secure memory device with computational capabilities, a device with at least one tamper-resistant chip, an electronic device associated with industrial control systems, or an embedded computer in a machine, or a combination thereof, wherein the machine comprises one of an airplane, a copier, a motor vehicle, or a microwave oven.

13. A method that facilitates location optimization comprising:
determining the location of a device, system, or combination thereof relative to at least one boundary zone; and
receiving at least one relevant update based at least in part on the determined location.

14. The method of claim 13, wherein the determination of the location further includes determinations about potential location zone transitions.

15. The method of claim 13, wherein the determination of the location is based at least in part on inferences related to the determined location, potential location zone transitions, or combinations thereof.

16. The method of claim 13, wherein the received at least one relevant update is at least in part searched for, downloaded in whole or in part, installed in whole or in part, made available in whole or in part, or combinations thereof.

17. The method of claim 16, wherein receiving the at least one relevant update is based on inferences related at least in part to the location determination, location zone transition determinations, or combinations thereof.

18. The method of claim 13, wherein the relevance of an update is based at least in part on the determined location, location zone transition, or combinations thereof.

19. The method of claim 13, wherein the relevance of an update is based at least in part on inferences about location, location zone transition, or combinations thereof.

20. The method of claim 13, wherein the determining the location of a device includes determinations of location zone transitions based at least in part on discrete zones, layered zones, a plurality of overlapping zones, positions relative to zone centers, or combinations thereof.
